(19) United States
(12) Patent Application Publication
(10) Pub. No.: US 2012/0305492 A1
(43) Pub. Date: Dec. 6, 2012

(54) RUNOFF COLLECTION SYSTEM WITH FIRST FLUSH CONTROL AND PRETREATMENT

(76) Inventors: Gregory W. Byrne, JR., West Linn, OR (US); Gregory T. Kowalsky, Portland, OR (US); Michael B. Brooks, Vancouver, WA (US); David R. Adams, Raymond, ME (US); John H. Pedrick, Portland, OR (US); Daniel W. Aberle, Portland, OR (US)

(21) Appl. No.: 13/325,692

(22) Filed: Dec. 14, 2011

Related U.S. Application Data
(60) Provisional application No. 61/424,426, filed on Dec. 17, 2010.

(51) Int. Cl. F16L 41/00; C02F 1/00

(52) U.S. Cl. 210/744; 210/170.03; 210/97; 137/561 A

(57) ABSTRACT

A rainwater collection system is described which includes generally a rainwater routing system and a collection unit. The rainwater routing system may comprise a first flush diversion unit designed to discharge to a run-off path, an initial amount of rainwater such that initial particulate matter from rooftops, etc., are not collected. The rainwater routing system may comprise a pre-treatment unit, the pre-treatment unit designed to remove particulate matter from the rainwater. The collection unit of the rainwater collection system comprises a storage tank having an internal day tank compartment. The described rainwater collection system allows for the collection of rainwater with a substantially reduced amount of particulate matter.

### CROSS-REFERENCE

This application claims the benefit of U.S. Provisional Application Ser. No. 61/424,426 filed Dec. 17, 2010, the entirety of which is incorporated herein by reference.

### TECHNICAL FIELD

This application relates generally to runoff collection systems and, more particularly, to a first flush control arrangement and/or a pretreatment arrangement and/or a storage tank having an internal day tank utilized in connection with a runoff collection system.

### BACKGROUND

Runoff collection systems (e.g., rainwater runoff collection systems) have been utilized for years. They are used to capture rainwater runoff and store it for later use. Rainwater collection systems often collect runoff water from building roofs utilizing a gutter and downspout system associated with the building to deliver the water to a collection tank or tanks that may be above or below. ground. Captured water is stored in the tank(s) for later use. One issue with such water collection systems is the need or desire to avoid collecting significant debris and pollutants in the storage tanks.

### SUMMARY

In one aspect, a rainwater collection system comprising a first flush diversion unit and a collection unit is provided, where the first flush diversion unit comprises an inlet which feeds water into the unit, a first outlet which directs rainwater to a run-off path, a second outlet which directs rainwater to a collection path, a diversion control device located internally of the unit, and a rainwater gauge, and the collection unit is configured for receiving rainwater from the collection path. The diversion control device has a first position forming a bypass mode and causing incoming water to be directed to the first outlet, and a second position forming a collection mode and causing incoming water to be directed to the second outlet. The position of the diversion control device is controlled by an actuator, the actuator acting in response to the rainwater gauge.

In another aspect, a rainwater collection system comprising a rainwater routing system, a pre-treatment unit, and a collection unit is provided, where the pre-treatment unit comprises an internal module for treatment, and a housing having an internal space, and comprising an inlet connected to receive rainwater from the rainwater routing system, an outlet which directs rainwater to a collection path, and a removable access lid. The internal module resides within the internal space of the housing. The collection unit is configured for receiving rainwater from the collection path, where rainwater from the rainwater routing system enters the pre-treatment unit via the inlet and is treated by the internal module to remove particulate from the rainwater, and the rainwater exits the pre-treatment unit via the outlet to the collection path.

In yet another aspect, a rainwater collection system comprising a rainwater routing system, and a collection unit is provided, where the collection unit comprises a storage tank having a first end, a second end, a width, a height, a first compartment, and an internal day tank compartment. The first compartment comprises an inlet, and a weir wall positioned between the first end and the second end of the storage tank and extending across the width of the storage tank, and having an opening governed by a one-way valve. The first compartment and the internal day tank compartment of the storage tank are separated by the weir wall. The internal day tank compartment comprises a pump, which when activated by demand, removes water from the internal day tank compartment of the storage tank via an outlet line, a water level sensor, and a fresh water make-up line which is in operational communication with the water level sensor. Rainwater entering the collection unit via the inlet passes into the first compartment and encounters the weir wall such that the rainwater rises on the inlet-side of the weir wall until the pressure against the one-way valve allows the rainwater to flow through the opening into the internal day tank compartment. Upon an indication from the water level sensor that the water in internal day tank compartment has dropped to a first predetermined level, the fresh water make-up line is opened to deliver fresh water into the internal day tank compartment and the one-way valve prevents such water from entering the first compartment.

In still another aspect, a method for collecting rainwater is provided. The method comprising (a) directing rainwater to a first flush diversion unit, (b) processing the rainwater from the first flush diversion unit in a pre-treatment unit, and (c) collecting the rainwater from the collection path of the pre-treatment unit in a collection unit. The first flush diversion unit comprises an inlet which feeds water into the unit, a first outlet which directs rainwater to a run-off path, a second outlet which directs rainwater to a collection path, a diversion control device located internally of the unit, and a rainwater gauge. The diversion control device has a first position forming a bypass mode and causing incoming water to be directed to the first outlet, and a second position forming a collection mode and causing incoming water to be directed to the second outlet. The position of the diversion control device is controlled by an actuator, the actuator acting in response to the rainwater gauge. The pre-treatment unit comprises an internal module comprising a screen member, and a housing having an internal space, and comprising an inlet connected to receive rainwater from the rainwater routing system, an outlet which directs rainwater to a collection path, and a removable access lid. The internal module resides within the internal space of the housing. The rainwater from the first flush diversion unit enters the pre-treatment unit via the inlet and thereby, passes through the screen member to remove particulate from the rainwater, and the rainwater exits the pre-treatment unit via the outlet. The collection unit comprises a storage tank having a first end, a second end, a width, a height, a first compartment, and an internal day tank compartment. The first compartment comprises an inlet, and a weir wall positioned between the first end and the second end of the storage tank and extending across the width of the storage tank, and having an opening governed by a one-way valve. The first compartment and the internal day tank compartment of the storage tank are separated by the weir wall. The internal day tank compartment comprises a pump, which when activated by demand, removes water from the internal day tank compartment of the storage tank via an outlet line, a water level sensor, and a fresh water make-up line which is in operational communication with the water level sensor. Rainwater entering the collection unit via the inlet passes into the first compartment and encounters the weir wall such that the rainwater rises on the inlet-side of the weir wall until the pressure against the one-way valve allows the rainwater to flow through the opening into the internal day tank compartment. Upon an indication from the water level sensor that the water in internal day tank compartment has dropped to a first predetermined level, the fresh water make-up line is opened to deliver fresh water into the internal day tank compartment and the one-way valve prevents such water from entering the first compartment.

### BRIEF DESCRIPTION OF THE DRAWINGS

FIG. 1A shows a rainwater collection system according to one embodiment of the invention.

FIG. 1B shows the rainwater collection system according to FIG. 1A in detail.

FIG. 1C shows the rainwater collection system according to FIG. 1B in detail.

FIG. 2A shows a first flush diversion unit according to one embodiment of the invention.

FIG. 2B shows an internal view of a first flush diversion unit in a bypass mode.

FIG. 2C shows an internal view of a first flush diversion unit in a collection mode.

FIG. 3A shows an external view of a pre-treatment unit according to one embodiment of the invention.

FIG. 3B shows an expanded view of a pre-treatment unit according to one embodiment of the invention.

FIG. 3C shows a schematic of water flow in a pre-treatment unit according to one embodiment of the invention.

FIG. 3D shows an internal module of a pre-treatment unit according to one embodiment of the invention.

FIG. 3E shows internal features of a housing of a pre-treatment unit according to one embodiment of the invention.

FIG. 3F shows an internal module of a pre-treatment unit according to another embodiment of the invention.

FIG. 4 shows a transverse view of a collection unit according to one embodiment of the invention.

FIG. 4A shows a view along line A-A of FIG. 4.

### DETAILED DESCRIPTION

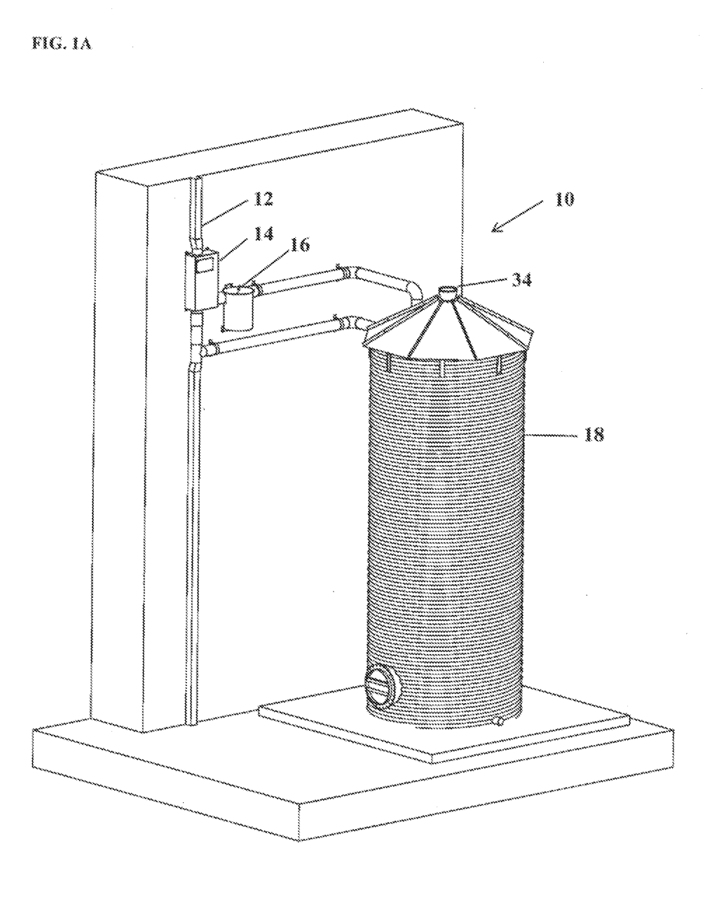

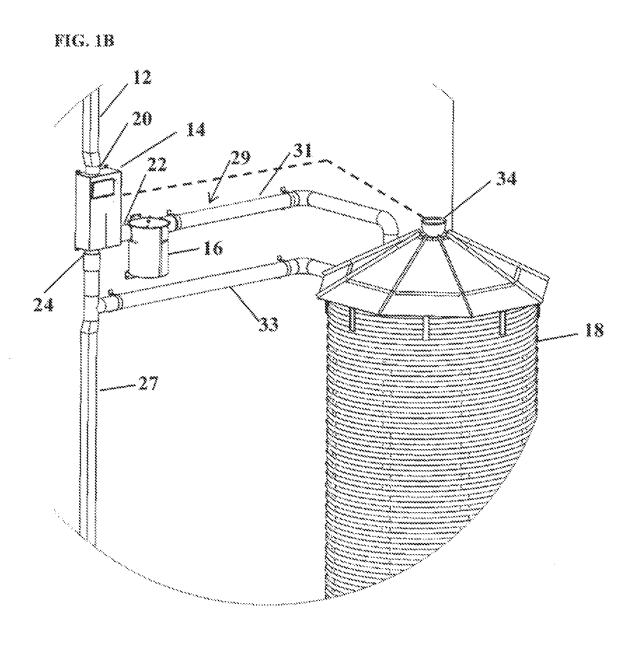

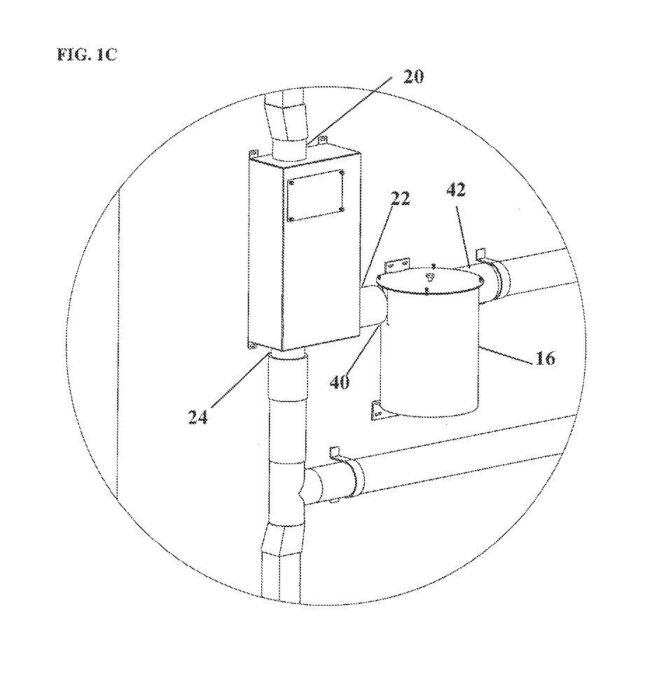

Referring to FIGS. 1A, 1B, and 1C, an exemplary rainwater collection system 10 includes a building downspout 12 (e.g., connected to a roof gutter system), a first flush diversion unit 14 and a pretreatment unit 16 that feed to one or more storage tanks 18.

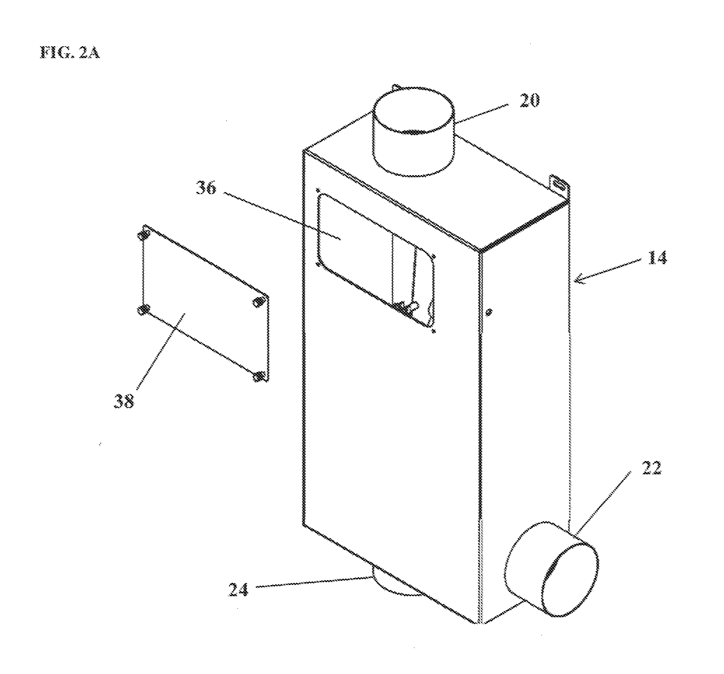

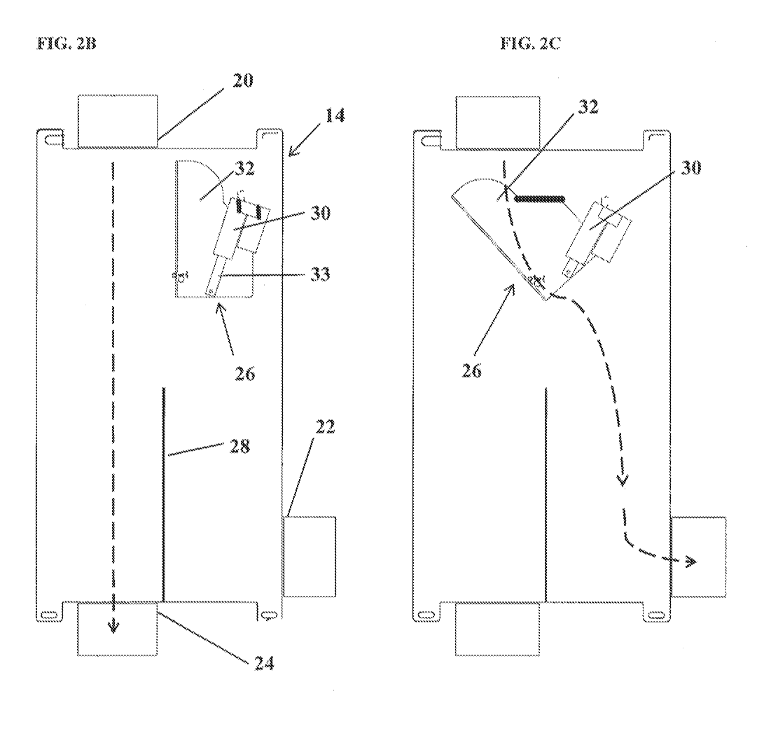

The first flush diversion unit 14 includes an inlet 20 and outlets 22 and 24. The downspout 12 connects to the inlet 20 to feed water into the unit 14. Internal of the unit a diversion control device 26 (FIGS. 2A, 2B and 2C) is located such that in one position (bypass mode (FIG. 2B)) the device causes or permits incoming water to flow to the outlet 24, while in another position (collection mode—FIG. 2C)) the device causes or permits water to flow to the outlet 22. An internal wall 28 of the diversion unit separates the two outlets 22 and 24. Outlet 22 feeds to a collection path that includes the pretreatment unit 16 and piping 31, while outlet 24 feeds to a traditional runoff path such as standard downspout piping 27 (e.g., typically a path that does not involve collection of the water for later use). The diversion control device 26 includes an associated actuator 30 (e.g., a pivotally mounted solenoid or motor with associated linear actuator rod 33) that is linked to control the position of the device 26. The actuator may be powered by standard line power or alternatively, by a battery, source of solar power, or any combination of the foregoing.

In the illustrated embodiment shown in FIGS. 2B and 2C, the device 26 takes the form of a channel or plate member or flapper 32 that is pivotably moveable between the two positions. In the collection mode position the channel member 32 is moved below the inlet 20 to cause the incoming water to flow over toward the outlet 22. The diversion control device 26 may be controlled based upon rainfall quantity. Specifically, a rainwater gauge 34 (FIGS. 1A and 1B) with associated electronic or electrical control may be used to monitor rainfall and control when the actuator moves the diversion control device from the bypass mode position to the collection mode position. In the illustrated example the rainwater gauge 34 is located above one of the tanks 18 and may detect when the rainwater reaches a specific level or depth (certain number of millimeters etc.), which may be adjustable. Of course, the location of the rainwater gauge could vary. When the specific level is detected, a signal is sent to the actuator 30 (e.g., via wire or wireless) and the actuator responds by moving the device 26. The device 26 is normally in the bypass mode position and is only moved to the collection mode position after the specific level of rainfall has occurred. After a predetermined amount of time without any rainfall, which may be adjustable, the device 26 resets to the bypass mode position. In this manner, the first flush or initial flow associated with a rain event flows straight through the device from input 20 to output 24 so that leaves, twigs, bird droppings, dead bugs or birds, rodents and other contaminants bypass the rainwater collection system. The cleaner water is then collected in the system for later use and after the rain event the system is reset to prepare for the next rain event. In addition, as shown in FIG. 2A, the first flush diversion unit 14 includes an access opening 36 that is closed by a removable panel 38 to enable the device 26 to be evaluated if necessary and to facilitate cleaning the interior of the unit.

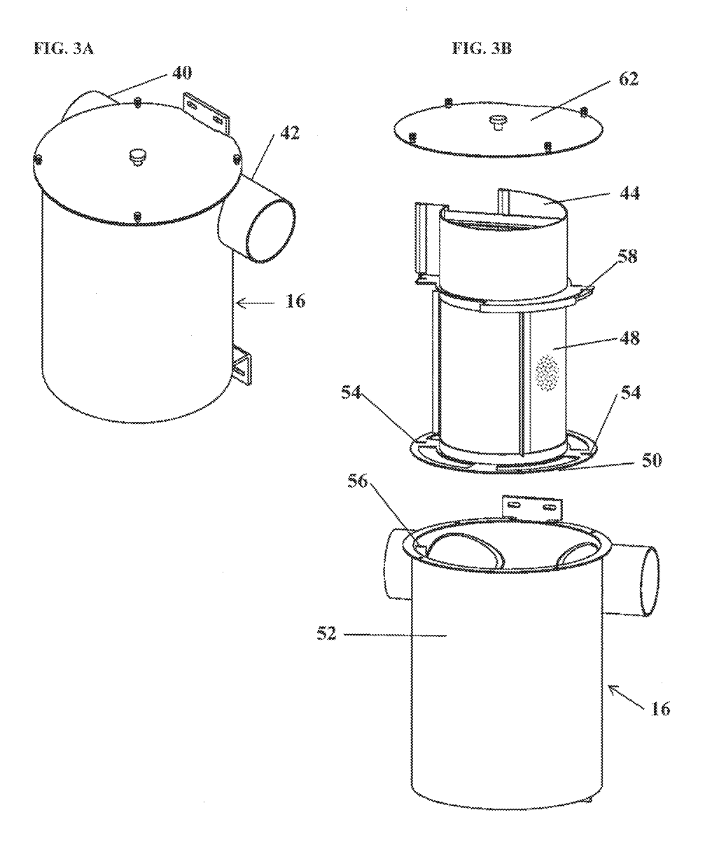

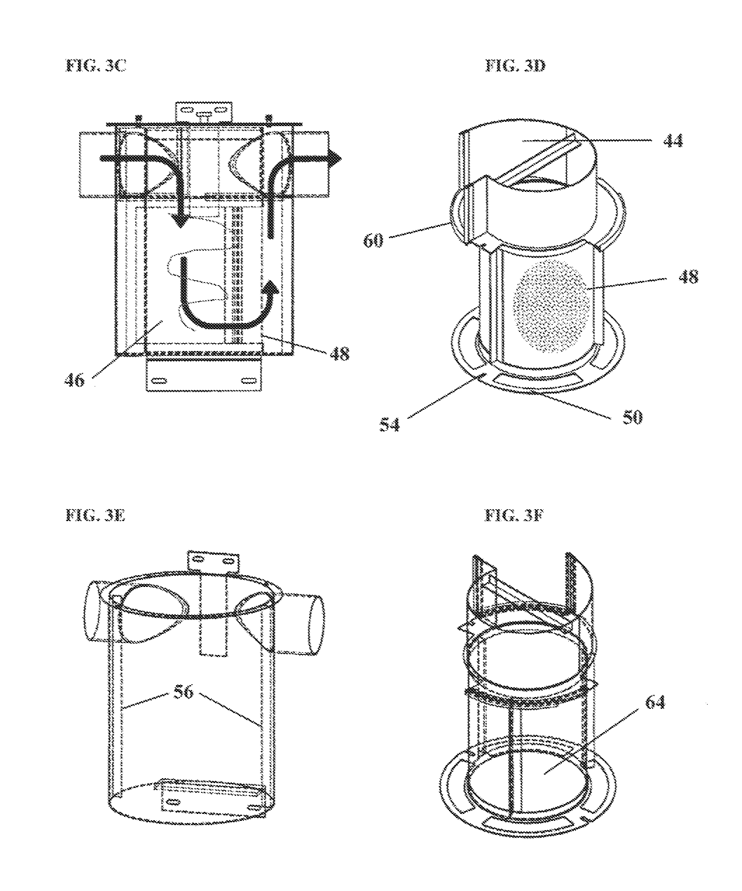

As shown in FIG. 3A, the pretreatment device 16 includes an inlet 40 and an outlet 42. The inlet is connected to receive flow from the first flush control device output 22. In the illustrated embodiment shown in expanded view in FIG. 3B, water entering the device 16 impinges, preferably tangentially or substantially tangentially, upon a curved internal deflector panel 44 and moves downward into a collection space 46 defined by lower screen member 48. The water must move outward through a lower screen member 48 (e.g., cylindrical in shape) that defines the collection space 46, as shown in FIG. 3C. In one example, the screen member may take the form of a continuous deflection screen such as that described in U.S. Pat. No. 5,788,848, which is hereby incorporated by reference herein in its entirety. After moving through the screen the water can then move back upward to exit through the space between the lower screen member and the housing and through outlet 42. In this manner, incoming debris can be trapped within the collection space to avoid such debris entering the collection tanks 18.

Referring to FIGS. 3B, 3D, and 3E, in one embodiment, the internal structure of the pretreatment device 16 is formed as removable module or unit, including a lower base ring 50 that is diametrically sized to match the internal diameter to the tank or housing 52 of the unit. The periphery of the ring may include one or more slots 54 that are positioned to align with angles or plates 56 that are mounted on the internal surface of the tank 52. In this manner, proper alignment of the module within the tank 52 is assured. The upper portion of the module also includes diametrically opposed edge trim members 58 and 60 that are sized to engage with the internal surface of the tank wall to help stabilize the module within the tank. The tank includes a removable access lid 62 for cleaning the collection space and/or for removing the module. The collection space may include a solid floor 64 (e.g., internal part of ring 50), as shown in FIG. 3F, so that any collected debris will stay with the module upon its removal, which can then be emptied by simply turning the module upside down.

An overflow path 33 (FIG. 1B) may also be provided from the storage tank 18 back to the traditional runoff path in the event the water flow into the storage tank exceeds the tank capacity.

While the primary embodiment illustrates use of an above-ground system that receives water from a gutter downspout, it is recognized that the various features of the invention could be implemented in a system in which the storage tank(s), diversion unit and/or pretreatment device are located underground. In addition, although the rainwater collection system shown in FIG. 1A utilizes an above ground vertical standing storage tank, it is recognized that a horizontally disposed storage tank can be used, as well as buried storage tanks. Also, while the first flush diversion unit and pretreatment unit of the primary embodiment are, in each case, shown as mounted on a building wall structure, other locations for such units are possible.

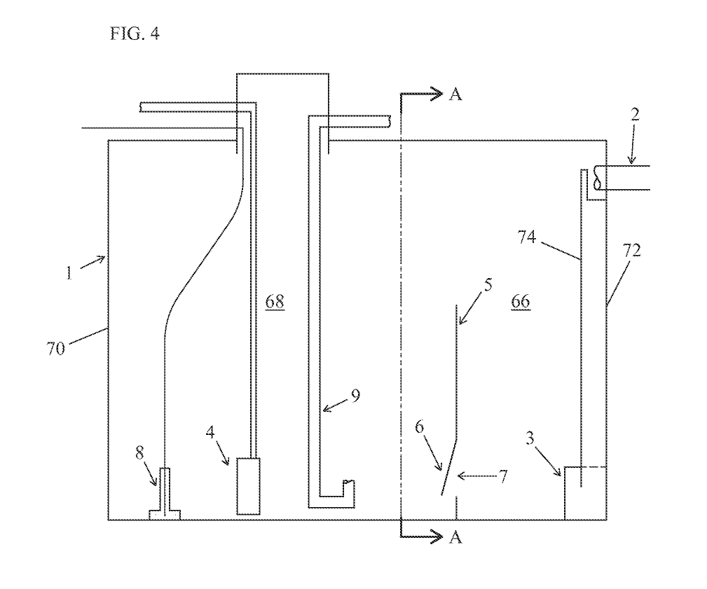

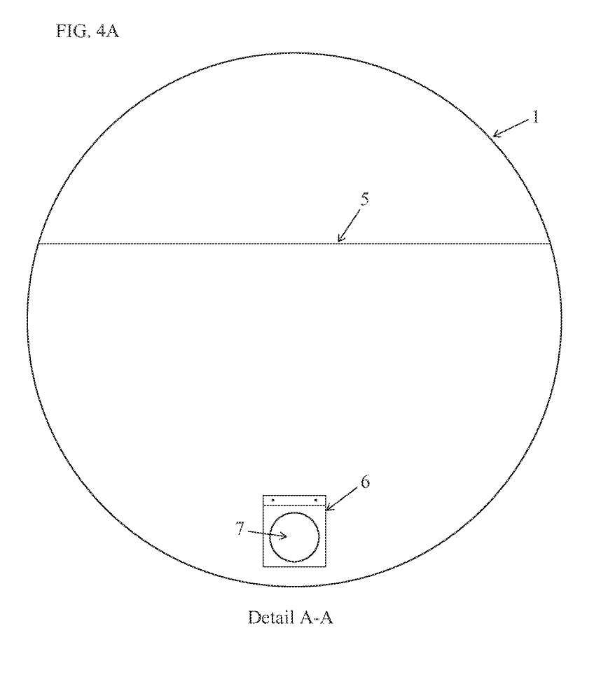

In one implementation, as shown in FIGS. 4 and 4A, the storage tank includes an internal day tank configuration as follows. Water enters the storage tank 1 through the inlet pipe 2 into a first compartment 66. In one embodiment, following the inlet pipe 2, the water encounters a calming inlet, comprising at least one baffle 74 and an overflow compartment 3. Water is allowed to enter an internal day tank compartment 68 behind (e.g. to the left in FIG. 4) the weir wall 5 through one way valve 6 and opening in the wall 7. The first compartment 66 and the internal day tank compartment 68 are separated by the weir wall 5. When water is called for from the tank, a pump 4 located in the internal day tank compartment is powered and level or depth in the tank 1 is reduced by pulling water from the internal day tank compartment 68. Level sensor 8 will indicate a low water level, and fresh water makeup line 9 is responsively activated (e.g., a valve is opened) to refill internal day tank compartment. The internal day tank compartment 68 fills and one-way valve 6 closes preventing water to traverse weir wall 5 through opening 7 as level of water rises above one way valve 6. When level sensor 8 indicates that peak refill level of the day tank side of the unit is achieved, the fresh water makeup line 9 is responsively turned off or closed. The remainder of storage tank 1, e.g. the first compartment 66, is available for storage of rainwater from next storm event. In one embodiment, the location of the weir wall 5 between a first side 70 and a second side 72 of the storage tank is variable. The amount of fresh water required to fill the internal day tank compartment can be set by appropriate positioning of the weir wall 5 within the storage tank and setting of the fill level triggered by the senor 8 so that a large volume is not needed and so that sufficient space remains in the tank to collect rainwater from the next storm event. Typically, the minimum internal day tank compartment volume (e.g., the amount of fresh water that would be called for if the day tank side of the unit was empty) may be set at between 40 and 100 gallons, though numerous variations are possible. In one embodiment, fresh water can be well or municipal water.

It is to be clearly understood that the above description is intended by way of illustration and example only and is not intended to be taken by way of limitation. For example, while the primary embodiment contemplates a storage tank formed of a tubular pipe structure (e.g., corrugated metal pipe or some form of plastic pipe such as steel reinforced plastic pipe), other collection unit structures could be used, including concrete or metal plate. Moreover, a collection unit could be formed of multiple interconnected tanks. Other variations are possible.

What is claimed is:

1. A rainwater collection system comprising
a first flush diversion unit, wherein the first flush diversion unit comprises
an inlet which feeds water into the unit,
a first outlet which directs rainwater to a run-off path,
a second outlet which directs rainwater to a collection path,
a diversion control device located internally of the unit, and
a rainwater gauge,
and a collection unit for receiving rainwater from the collection path,
wherein the diversion control device has a first position forming a bypass mode and causing incoming water to be directed to the first outlet, and a second position forming a collection mode and causing incoming water to be directed to the second outlet, and wherein the position of the diversion control device is controlled by an actuator, the actuator acting in response to the rainwater gauge.

2. The system of claim 1 wherein the diversion control device is a channel member, plate member, or flapper.

3. The system of claim 1 wherein the actuator is powered by standard line power, a battery, a source of solar power, or a combination thereof.

4. The system of claim 1 wherein the rainwater gauge detects when rainwater reaches a predetermined level and in response to the detection, sends a control signal to the actuator.

5. The system of claim 1 wherein the diversion control device is normally in the first position and following detection of a predetermined level in the rainwater gauge, the diversion control device is moved to the second position.

6. The system of claim 5 wherein after a predetermined amount of time without rainfall, the diversion control device resets to the first position.

7. The system of claim 1 wherein the first flush diversion unit further comprises an access opening and an associated removable panel, the access opening allowing access to the interior of the first flush diversion unit.

8. The system of claim 1 further comprising a pre-treatment unit forming part of the collection path and located downstream of the first flush diversion unit and upstream of the collection unit, the pre-treatment unit configured to remove particulate from the rainwater.

9. The system of claim 1 wherein the collection unit comprises a storage tank comprising a first compartment and an internal day tank compartment separated by a weir wall.

10. The system of claim 1 wherein the rainwater gauge is located on a top surface of the collection unit.

11. A rainwater collection system comprising
a rainwater routing system,
a pre-treatment unit, wherein the pre-treatment unit comprises
a housing having an internal space holding an internal module for treatment, the housing comprising
an inlet connected to receive rainwater from the rainwater routing system,
an outlet which directs rainwater to a collection path, and
a removable access lid, wherein the internal module resides within the internal space of the housing,
and a collection unit for receiving rainwater from the collection path,
wherein rainwater from the rainwater routing system enters the pre-treatment unit via the inlet and is treated by the internal module to remove particulate from the rainwater, and wherein rainwater exits the pre-treatment unit via the outlet to the collection path.

12. The system of claim 11 wherein the internal module of the pre-treatment unit is removable through the an opening covered by the access lid.

13. The system of claim 11 wherein the internal module of the pre-treatment unit comprises a deflector panel, and a screen member of the internal module forms an interior, collection space, wherein rainwater is diverted by the deflector panel to the collection space, and wherein rainwater exits the collection space through the screen member into a space between the screen member and the housing, and exits the pre-treatment unit via the outlet.

14. The system of claim 11 wherein the internal module of the pre-treatment unit further comprises at least one upper trim member and a lower base ring, wherein the at least one upper trim member and lower base ring are configured to match dimensions of the internal space of the housing.

15. The system of claim 13 wherein the deflector panel of the internal module is curved.

16. The system of claim 13 wherein the inlet of the housing is located substantially opposite to the outlet of the housing, and wherein the deflector plate is disposed substantially between the inlet and the outlet.

17. The system of claim 11 wherein particulate, which may be present in the rainwater, is substantially retained by a screen member of the internal module.

18. The system of claim 12 wherein the internal module further comprises a floor plate, such that removal of the internal module from the housing also removes any particulate in a collection space of the internal module.

19. The system of claim 11 wherein the rainwater routing system comprises a first flush diversion unit that selectively delivers rainwater to the pre-treatment unit based upon a detected amount of rainfall.

20. The system of claim 10 wherein the collection unit comprises a storage tank comprising a first compartment and an internal day tank compartment separated by a weir wall.

21. A rainwater collection system comprising
a rainwater routing system, and
a collection unit, wherein the collection unit comprises
a storage tank having a first end, a second end, a width, a height, and a first compartment, the first compartment comprising
an inlet, and
a weir wall positioned between the first end and the second end of the storage tank and extending across the width of the storage tank, and having an opening governed by a one-way valve, and
an internal day tank compartment disposed within the storage tank, wherein the first compartment and the internal day tank compartment of the storage tank are separated by the weir wall, and the internal day tank compartment comprises
a pump, which when activated by demand, removes water from the internal day tank compartment of the storage tank via an outlet line,
a water level sensor, and
a fresh water make-up line which is in operational communication with the water level sensor,
wherein rainwater entering the collection unit via the inlet passes into the first compartment and encounters the weir wall such that the rainwater rises on the inlet-side of the weir wall until the pressure against the one-way valve allows the rainwater to flow through the opening into the internal day tank compartment, and wherein, upon an indication from the water level sensor that the water in internal day tank compartment has dropped to a first predetermined level, the fresh water make-up line is opened to deliver fresh water into the internal day tank compartment and the one-way valve prevents such water from entering the first compartment.

22. The system of claim 21 further comprising a calming inlet module located downstream of the inlet, and comprising a baffle and overflow compartment, wherein rainwater from the inlet is directed, via the baffle, to the overflow compartment, whereupon the rainwater flowing out of the overflow compartment enters the first compartment.

23. The system of claim 21 wherein the weir wall has a height which is less than the height of the storage tank.

24. The system of claim 21 wherein the position of the weir wall between the first end and the second end of the storage is variable, such that the size of the first compartment and the internal day tank compartment can be selected.

25. The system of claim 21 wherein the amount of fresh water needed to fill the internal day tank compartment can be selected by varying the size of the internal day tank compartment.

26. The system of claim 21 wherein the internal day tank compartment has a volume of between about 40 gallons to about 100 gallons.

27. The system of claim 21 wherein the fresh water is selected from well water or municipal water.

28. The system of claim 21 wherein the rainwater routing system comprises a first flush diversion unit and a pre-treatment unit located downstream of the first flush diversion unit and upstream of the collection unit.

29. A method for collecting rainwater, the method comprising
(a) directing rainwater to a first flush diversion unit, wherein the first flush diversion unit comprises
an inlet which feeds the rainwater into the first flush diversion unit,
a first outlet which directs rainwater to a non-collection, run-off path,
a second outlet which directs rainwater to a collection path,
a diversion control device located internally of the unit, and
a rainwater gauge,
wherein the diversion control device has a first position forming a bypass mode and causing incoming water to be directed to the first outlet, and a second position forming a collection mode and causing incoming water to be directed to the second outlet, and wherein the position of the diversion control device is controlled by an actuator, the actuator acting in response to the rainwater gauge;
(b) processing the rainwater from the first flush diversion unit in a pre-treatment unit, wherein the pre-treatment unit comprises
an internal module comprising a screen member, and
a housing having an internal space, and comprising
an inlet connected to receive rainwater from the first flush diversion unit,
an outlet which directs rainwater to a collection path, and
a removable access lid, wherein the internal module resides within the internal space of the housing,
wherein rainwater from the first flush diversion unit enters the pre-treatment unit via the inlet, and thereby, passes through the screen member to remove particulate from the rainwater, and wherein rainwater exits the pre-treatment unit via the outlet to the collection path; and
(c) collecting the rainwater from the collection path of the pre-treatment unit in a collection unit, wherein the collection unit comprises
a storage tank having a first end, a second end, a width, a height, and a first compartment, the first compartment comprising
an inlet, and
a weir wall positioned between the first end and the second end of the storage tank and extending across the width of the storage tank, the weir wall having an opening governed by a one-way valve, and
an internal day tank compartment disposed within the storage tank, wherein the first compartment and the internal day tank compartment of the storage tank is separated by the weir wall, and the internal day tank compartment comprises
a pump, which when activated by demand, removes water from the internal day tank compartment of the storage tank via an outlet line,
a water level sensor, and
a fresh water make-up line which is in operational communication with the water level sensor,
wherein rainwater entering the collection unit via the inlet passes into the first compartment and encounters the weir wall such that the rainwater rises on the inlet-side of the weir wall until the pressure against the one-way valve allows the rainwater to flow through the opening into the internal day tank compartment, and wherein, upon an indication from the water level sensor that the water in internal day tank compartment has dropped to a first predetermined level, the fresh water make-up line is opened to deliver fresh water into the internal day tank compartment and the one-way valve prevents such water from entering the first compartment,
wherein rainwater is collected which has a reduced level of particulate as compared to the rainwater directed to first flush diversion unit.

30. The method of claim 29 wherein the collected rainwater is substantially free of particulate.
